(19) United States
(12) Patent Application Publication
(10) Pub. No.: US 2016/0011411 A1
(43) Pub. Date: Jan. 14, 2016

(54) ANTI-PEEPING DEVICE AND CONTROL METHOD

(71) Applicant: BOE Technology Group Co., Ltd., Beijing (CN)

(72) Inventors: Xinan Wang, Beijing (CN); Wenbo Li, Beijing (CN)

(21) Appl. No.: 14/547,411

(22) Filed: Nov. 19, 2014

(30) Foreign Application Priority Data
Jul. 11, 2014 (CN) 201410331745.6

(51) Int. Cl. G02B 26/02; G06F 3/03; G06K 9/00; G02B 5/00; G02B 5/08

(52) U.S. Cl. CPC G02B 26/02; G02B 5/003; G02B 5/08; G06K 9/00288; G06K 9/00228; G06F 3/0304

(57) ABSTRACT

The present invention provides an anti-peeping device comprising: a plate-shaped substrate; a transparent cover plate disposed in parallel with the plate-shaped substrate; and a plurality of light blocking walls between the transparent cover plate and the plate-shaped substrate, the plurality of light blocking walls being disposed in parallel with and spaced apart from one another. A first end of each light blocking wall is deflectably connected to the plate-shaped substrate, and a second end of each light blocking wall opposite to the first end is deflectably connected to the transparent cover plate, such that each light blocking wall is deflected when the transparent cover plate moves relative to the plate-shaped substrate. The present invention further provides a control method for the anti-peeping device.

### CROSS-REFERENCE TO RELATED APPLICATION

This application claims the benefit of Chinese Patent Application No. 201410331745.6 filed on Jul. 11, 2014 in the State Intellectual Property Office of China, the whole disclosure of which is incorporated herein by reference.

### BACKGROUND OF THE INVENTION

1. Field of the Invention

The present invention relates to the field of display technology, and more specifically to an anti-peeping device for a display device and a control method for the anti-peeping device.

2. Description of the Related Art

At present, a conventional anti-peeping device or anti-peeping film is based on grating-type light blocking walls that blocks light at certain viewing angles, so that a user can watch contents output by a display device only at an allowed range of viewing angle. If a user stands out of the allowed range predetermined during manufacture of the anti-peeping device, he/she will not be able to watch the contents of the display device because of the grating-type light blocking walls.

For example, an existing grating type anti-peeping device is shown in FIG. 1. The anti-peeping device comprises a plate-shaped substrate 1, and a plurality of light blocking walls 2 fixed on the plate-shaped substrate 1. Each of the light blocking walls 2 is disposed perpendicularly to the plate-shaped substrate 1. As shown in FIG. 1, depending on the way in which each of the light blocking walls 2 is disposed, a region between a sightline a and a sightline b is an allowed watching region, and a region at the left side of the sightline a and a region at the right side of the sightline b are an unallowed watching regions. Users standing in the allowed watching region can watch at least parts of the content from a display device, and users standing in the unallowed watching region cannot watch the content from the display device totally or at least cannot watch the content from the display device clearly.

In another example, as shown in FIG. 2, a plurality of light blocking walls 2 are fixed on the plate-shaped substrate 1, and each of the light blocking walls 2 is inclined towards the left side, so that it forms a sharp angle to the left side of the plate-shaped substrate 1, and forms an obtuse angle to the right side of the plate-shaped substrate 1. As shown in FIG. 2, depending on the way in which each of the light blocking walls 2 is disposed, a region between a sightline a and a sightline b is an allowed watching region, and a region at the left side of the sightline a and a region at the right side of the sightline b are non-viewable regions. Users standing in the viewable region can watch at least parts of the content from a display device, and users standing in the non-viewable region cannot watch the content from the display device totally or at least cannot watch the content from the display device clearly.

In a further example, as shown in FIG. 3, a plurality of light blocking walls 2 are fixed on the plate-shaped substrate 1 and each of the light blocking walls 2 is inclined towards the right side, so that it forms a sharp angle to the right side of the plate-shaped substrate 1, and forms an obtuse angle to the left side of the plate-shaped substrate 1. As shown in FIG. 3, depending on the way in which each of the light blocking walls 2 is disposed, a region between a sightline a and a sightline b is an allowed watching region, and a region at the left side of the sightline a and a region at the right side of the sightline b are unallowed watching regions. Users standing in the allowed watching region can watch at least parts of the content from a display device, and users standing in the unallowed watching region cannot watch the content from the display device totally or at least cannot watch the content from the display device clearly.

From the above examples, the inventor finds that, since the light blocking walls 2 are fixedly attached to the plate-shaped substrate 1, the angle formed between each light blocking wall 2 and the plate-shaped substrate 1 is fixed. That is to say, a light blocking angle of each light blocking wall 2 is fixed, and the allowed watching region and the unallowed watching regions are also fixed. If a user wants to change the allowed watching region and the unallowed watching regions, he or she has to replace the anti-peeping device with another one of a different type.

Therefore, safety and applicability of current anti-peeping devices are poor, and users have to buy different anti-peeping devices, which leads to a high cost.

### SUMMARY OF THE INVENTION

The present invention has been made to overcome or alleviate at least one aspect of the above mentioned disadvantages.

Accordingly, an object of the present invention is to provide an anti-peeping device.

According to one embodiment of the present invention, an anti-peeping device comprises: a plate-shaped substrate; a transparent cover plate disposed in parallel with the plate-shaped substrate; and a plurality of light blocking walls between the transparent cover plate and the plate-shaped substrate, the plurality of light blocking walls being disposed in parallel with and spaced apart from one another. A first end of each light blocking wall is deflectably connected to the plate-shaped substrate, and a second end of each light blocking wall opposite to the first end is deflectably connected to the transparent cover plate, such that each light blocking wall is deflected correspondingly when the transparent cover plate moves relative to the plate-shaped substrate.

According to another embodiment of the present invention, the anti-peeping device further comprises a manual adjusting device for controlling a relative position relationship between the transparent cover plate and the plate-shaped substrate. The manual adjusting device comprises: a connecting rod with one end thereof connected to the transparent cover plate, the connecting rod comprising screw threads on its outer surface; and a knob having a threaded hole for engaging with the screw threads of the connecting rod. The knob is threaded onto the connecting rod and is retained at a fixed position relative to the plate-shaped substrate, such that rotation of the knob causes the connecting rod to move and in turn causes the transparent cover plate to move relative to the plate-shaped substrate.

According to another embodiment of the present invention, the anti-peeping device further comprises an automatic adjusting device for controlling a relative position relationship between the transparent cover plate and the plate-shaped substrate. The automatic adjusting device comprises: a leading screw; a nut threaded onto the leading screw, the nut being securely connected to the transparent cover plates; a driving device for rotating the leading screw; an input unit for receiving an instruction from a user; and a controller configured to control the driving device based on the instruction to rotate the leading screw so that the nut is moved along the leading screw.

According to another embodiment of the present invention, the anti-peeping device further comprises: a driving device for moving the transparent cover plate; an information acquiring device for acquiring features of a current user's face; and a control device for storing therein predetermined features of a predetermined user's face. The control device is configured to receive the acquired features, conduct a comparison between the acquired features and the predetermined features, and control the driving device and the information acquiring device based on a result of the comparison.

Another object of the present invention is to provide control methods for the above anti-peeping devices.

According to one embodiment of the present invention, a control method for an anti-peeping device comprises: moving the transparent cover plate; stopping moving the transparent cover plate when the transparent cover plate has been moved to a desired position; and fixing the position of the transparent cover plate relative to the plate-shaped substrate.

According to another embodiment of the present invention, a control method for an anti-peeping device comprises: presetting predetermined features of a predetermined user's face; acquiring features of a current user's face; conducting a comparison between the acquired features and the predetermined features to determine whether or not the current user is the predetermined user; and controlling the anti-peeping device based on a result of the comparison.

With the anti-peeping device of the present application, the unallowed range of viewing angle of the anti-peeping device can be changed to improve the anti-peeping performance. Furthermore, since the unallowed range of viewing angle of the anti-peeping device can be changed, users do not have to replace the anti-peeping device to change the allowed and the unallowed watching regions, so that overall usage cost of the anti-peeping device can be reduced.

### BRIEF DESCRIPTION OF THE DRAWINGS

The above and other features of the present invention will become more apparent by describing in detail exemplary embodiments thereof with reference to the accompanying drawings, in which:

FIG. 1 is a structure schematic drawing of an existing anti-peeping device;

FIG. 2 is a structure schematic drawing of another existing anti-peeping device;

FIG. 3 is a structure schematic drawing of still another existing anti-peeping device;

FIG. 4 is a structure schematic drawing of an anti-peeping device according to a first embodiment of the present invention;

FIG. 5 is a schematic drawing of the anti-peeping device of FIG. 4, showing the principle of the anti-peeping device;

FIG. 6 is a structure schematic drawing of an anti-peeping device according to a second embodiment of the present invention;

FIG. 7 is a structure schematic drawing of an anti-peeping device according to a third embodiment of the present invention;

FIG. 8 is a structure schematic drawing of an anti-peeping device according to a fourth embodiment of the present invention;

FIG. 9 is an illustrative flow chart of a control method for the anti-peeping device according to the first embodiment of the present invention;

FIG. 10 is an illustrative flow chart of a control method for the anti-peeping device according to the second embodiment of the present invention;

FIG. 11 is an illustrative flow chart of a control method for the anti-peeping device according to the third embodiment of the present invention; and

FIG. 12 is an illustrative flow chart of a control method for the anti-peeping device according to the fourth embodiment of the present invention.

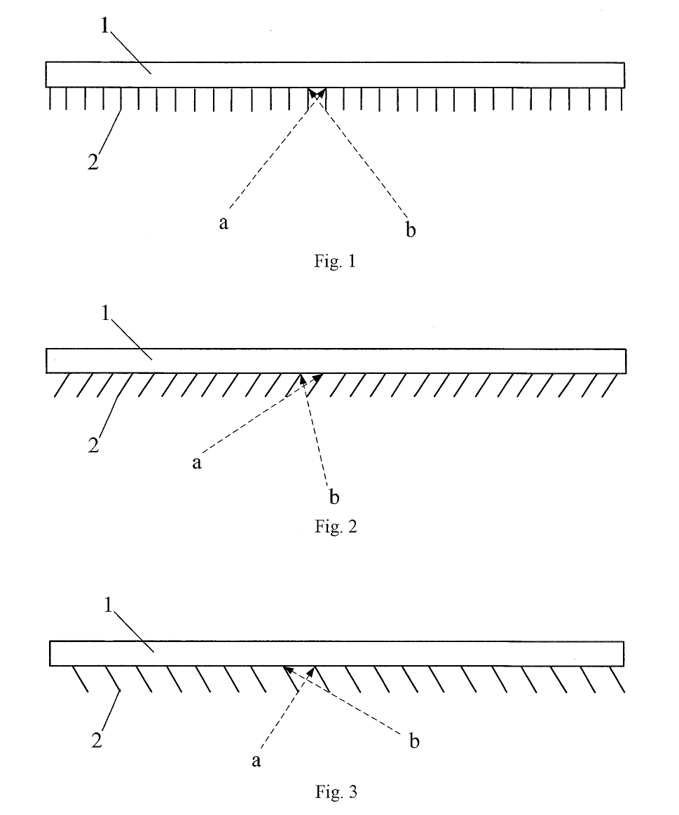

### LIST OF REFERENCE NUMBERS OF THE DRAWINGS

1: plate-shaped substrate

2: light blocking wall

3: transparent cover plate

4: flexible isolator

5: connecting rod

6: knob

7: motor

8: screw

9: nut

10: control device

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

It is to be noted that, throughout the specification, the terms indicating directions or position relations, such as “center”, “up”, “down”, “front”, “rear”, “left”, “right”, “vertical”, “horizontal”, “top”, “bottom”, “inner”, and “outer”, are based on the attached drawings, and are used to simplify the description of the present invention. These terms do not mean to indicate or imply that certain device or component should have a certain orientation or should be specifically constructed, and these terms should not be considered as a limitation to the present invention. Besides, the term “connection” used herein may be an “electrical connection”, a “wireless connection”, and/or a “physical connection”, as long as such a connection could achieve desired effect.

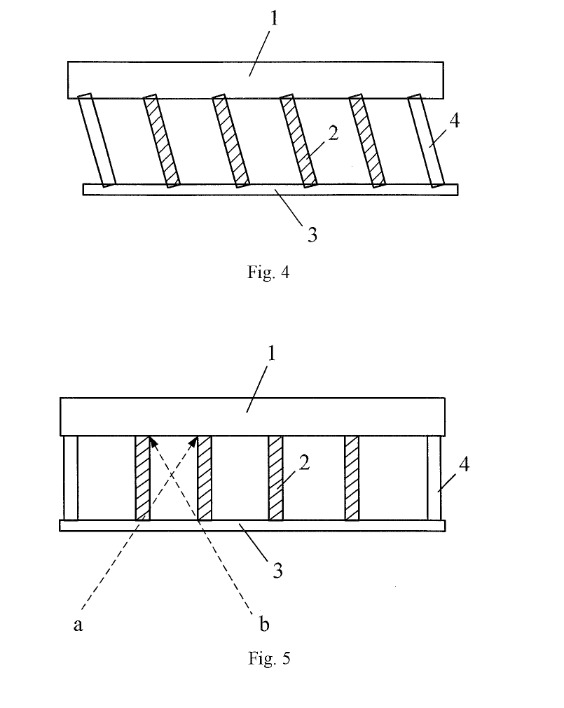

An anti-peeping device according to the first embodiment of the present invention is shown in FIGS. 4 and 5. As shown in FIG. 4, the anti-peeping device according to the first embodiment comprises a transparent plate-shaped substrate 1, a transparent cover plate 3, and a plurality of light blocking walls 2 deflectably disposed between the plate-shaped substrate 1 and the transparent cover plate 3. The plurality of light blocking walls 2 are disposed to be spaced apart from and in parallel with one another. One end of each light blocking wall 2 is deflectably connected to the plate-shaped substrate 1, while the other end is deflectably connected to the transparent cover plate 3. Therefore, as shown in FIGS. 4 and 5, when the transparent cover plate 3 is moved relative to the plate-shaped substrate 1, each light blocking wall 2 is deflected by the movement of the transparent cover plate 3.

The transparent cover plate 3 may be formed by transparent resin or transparent glass. The plate-shaped substrate 1 may be a separate component, such as a transparent substrate. When using the anti-peeping device, the transparent substrate may be fixed to a display panel through adhesion, embedding, or any other suitable ways. Instead of being a separate component, the plate-shaped substrate 1 may also be the display panel or a part of the display panel, such as a color filter substrate, so that the light blocking walls 2 and the transparent cover plate 3 could be directly formed on the display panel, and the light emitted by the display panel could directly pass through the space between adjacent the light blocking walls 2, and the entire weight and cost of the anti-peeping device could thereby be reduced.

The cross section of each light blocking wall 2 may be in shape of a triangle, a trapezoid, or a rectangle. As shown in FIG. 4, the shape of the cross section of each light blocking wall 2 is a rectangle. The light blocking walls 2 are disposed to be spaced apart from one another, and the intervals between adjacent light blocking walls 2 may be constant or not constant. For example, in order to improve the performance of displaying, no light blocking wall 2 is disposed in a predetermined region that directly faces the user, the light blocking walls 2 are disposed outside the predetermined region, such that the intervals between adjacent light blocking walls 2 are not constant. Alternatively, the intervals between adjacent light blocking walls 2 are constant, so that an allowed range of viewing angle of the anti-peeping device will be kept constant throughout the anti-peeping device, and thereby the anti-peeping performance will be improved. The light blocking walls 2 are arranged in parallel with each other so that ends of light blocking walls 2 that are connected to the plated-shaped substrate 1 are in parallel with each other, and light blocking faces of the light blocking walls 2 are in parallel with each other.

As shown in FIG. 5, when each light blocking wall 2 is disposed perpendicular to the plated-shaped substrate 1, a region between a sightline a and a sightline b is an allowed watching region, and a region at the left side of the sightline a and a region at the right side of the sightline b are unallowed watching regions. If the allowed watching region and the unallowed watching regions are required to be changed, that is, if the allowed range of viewing angle or an unallowed range of viewing angle is to be changed, the user may move the transparent cover plate 3 to the left or to the right so as to change the allowed range of viewing angle, due to the deflectable connection between one end of each light blocking wall 2 and the plate-shaped substrate 1 and the deflectable connection between the other end of each light blocking wall 2 and the transparent cover plate 3.

From the above, with the anti-peeping device according to the embodiment of the present application, the allowed range of viewing angle can be changed as required. In contrast to existing anti-peeping device whose light blocking walls are fixed, anti-peeping performance and applicability of the anti-peeping device according to the embodiment of the present application can be significantly improved. Therefore, the allowed range of viewing angle can be changed without replacing a current anti-peeping device with one of a different type, and overall cost can be reduced.

As stated above, one end of each light blocking wall 2 is deflectably connected to the plate-shaped substrate 1, and the other end is deflectably connected to the transparent cover plate 3. The ability of deflection of the light blocking walls 2 can be achieved through many different ways. For example, each light blocking wall 2 may be a rigid light blocking wall, one end of which is connected to the plate-shaped substrate 1 via a flexible connection, and the other end of which is connected to the transparent cover plate 3 also via a flexible connection, so that the light blocking wall 2 is deflectable with respect to the plate-shaped substrate 1 and the transparent cover plate 3. Or, each light blocking wall 2 may be a flexible light blocking wall, such that each light blocking wall 2 may be directly connected to the plate-shaped substrate 1 and the transparent cover plate 3, because the light blocking wall itself can provide the deflection characteristic.

The above anti-peeping device's anti-peeping effect is achieved by light blocking walls 2 that block sightline in a certain range. Specifically, hereinafter, the region between two adjacent light blocking walls 2 is referred to as a light transmitting region, through which the light from the display panel can pass. A face of each light blocking wall 2 that faces the transmitting region is referred to as a light blocking face. An unallowed range of viewing angle can be changed through changing the angle between each light blocking wall 2 and the plate-shaped substrate 1 or the transparent cover plate 3. The light blocking face may be a light absorbing face. The light absorbing face can be achieved by manufacturing the light blocking wall 2 from a light absorbing material, or by applying a light absorbing layer made from a light absorbing material to the sides of the light blocking wall 2. In another exemplary embodiment, the light blocking face may be a light reflecting face. The light absorbing face can be achieved by manufacturing the light blocking wall 2 from a light reflecting material, or by applying a light reflecting layer made from a light reflecting material to the sides of the light blocking wall 2.

In order to protect the anti-peeping device from damages due to unsuitable operations and improve service life of the anti-peeping device, the anti-peeping device alternatively comprises at least two flexible isolators 4 disposed between the plate-shaped substrate 1 and the transparent cover plate 3, as shown in FIGS. 4 and 5. Each of the flexible isolators 4 is connected at its two ends to peripheral portions of plate-shaped substrate 1 and the transparent cover plate 3, respectively. Specifically, as shown in FIG. 4, both the plate-shaped substrate 1 and the transparent cover plate 3 are in a shape of a rectangle, and the two flexible isolators 4 are disposed on two opposite outer sides of the plurality of light blocking walls 2 respectively to be in parallel with each of the light blocking walls 2. The flexible isolators 4 may support the transparent cover plate 3 and prevent the transparent cover plate 3 from falling onto the plate-shaped substrate 1 and damaging the light blocking walls 2 due to gravity or unsuitable operations, such that service life of the anti-peeping device can be improved.

In an exemplary embodiment, four flexible isolators 4 are provided. The four flexible isolators 4 are disposed at four outer edges of the rectangular plate-shaped substrate 1 respectively, and adjacent flexible isolators are interconnected to form an integral structure. In such a way, the four flexible isolators 4 can form a sealing structure for preventing dirt or debris from coming into the anti-peeping device while supporting the transparent cover plate 3.

In order to stop or locate the transparent cover plate 3 at any position relative to the plate-shaped substrate 1, and prevent the light blocking walls 2 from returning back to their original position under the restoration effect of the light blocking walls 2 or the flexible connections, a fixing device (not shown) may be provided to locate the transparent cover plate 3 at any desired position. In an unshown embodiment, the fixing device may be provided on the transparent cover plate 3. Specifically, the fixing device may comprise a rack fastened to the transparent cover plate 3 and extending in a direction along which the transparent cover plate 3 moves, and a toothed component fastened to the plate-shaped substrate 1 and extending toward the transparent cover plate 3. The teeth of the rack and the teeth of the toothed component may engage with each other at several different positions so as to locate the transparent cover plate 3. In an alternate embodiment, the rack and the toothed component can be interchanged.

When a user presses his finger on the outer surface of the transparent cover plate 3 that faces away from the plate-shaped substrate 1 and moves his finger, the friction force between the finger and the outer surface of the transparent cover plate 3 may force the transparent cover plate 3 to move. When the transparent cover plate 3 is moved to a desired position, the rack and the toothed component are engaged, so that the transparent cover plate 3 is stopped at the desired position and the unallowed range of viewing angle will be prevented from being changed due to the returning of the transparent cover plate 3 caused by restoration effect of the light blocking walls 2.

The light blocking walls 2 may be damaged or broken if the displacement of the transparent cover plate 3 is too large. Therefore, a stopping device (not shown) may be provided to limit the maximum displacement of the transparent cover plate 3 relative to the plate-shaped substrate 1 in a right and left direction. In an unshown exemplary embodiment, the stopping device may comprise a frame structure disposed around and spaced apart from the transparent cover plate 3. The distance between the frame structure and the transparent cover plate 3 limits a maximum displacement of the transparent cover plate 3 relative to the plate-shaped substrate 1 in the right and left direction. In another unshown exemplary embodiment, the stopping device may comprise two stop plates or stop blocks positioned respectively at a distance from two opposite sides, for example, the left side and the right side, of the transparent cover plate 3 respectively, so as to limit the maximum displacement of the transparent cover plate 3 and prevent the transparent cover plate 3 from moving excessively.

In the anti-peeping device according to the above embodiment, the unallowed range of viewing angle can be changed by moving the transparent cover plate 3 relative to the plate-shaped substrate 1 such that the light blocking walls 2 are deflected simultaneously. The simplest way is to press a finger on the outer surface of the transparent cover plate 3 so as to cause the transparent cover plate 3 to move under the friction force between the finger and the transparent cover plate 3. However, pressing a finger and utilizing the friction force to move the transparent cover plate 3 may be laboursome and will leave fingerprint on the outer surface of the transparent cover plate 3, so that it will adversely affect aesthetic feeling and display performance. Therefore, in an unshown exemplary embodiment, a rod connected to one end of the transparent cover plate 3 may be provided, and the transparent cover plate 3 may be caused to move relative to the plate-shaped substrate 1 by pulling or pushing the rod, and therefore the light blocking walls 2 are deflected simultaneously.

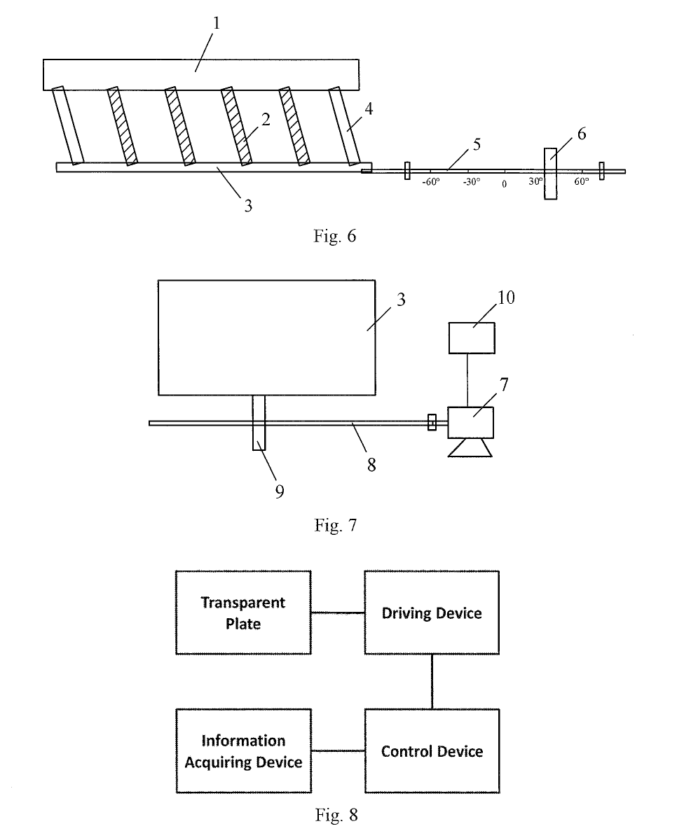

An anti-peeping device according to the second embodiment of the present invention is shown in FIG. 6. The anti-peeping device in the second embodiment is similar to the anti-peeping device in the first embodiment except that the anti-peeping device in the second embodiment further comprises a manual adjusting device for accurately adjusting the unallowed range of viewing angle of the light blocking walls 2.

In order to accurately adjust the unallowed range of viewing angle of the light blocking walls 2, as shown in FIG. 6, the anti-peeping device further comprises a manual adjusting device for controlling the displacement of the transparent cover plate 3 relative to the plate-shaped substrate 1. The manual adjusting device comprises a connecting rod 5 and a knob 6, one end of the connecting rod 5 is securely connected to the transparent cover plate 3, and the connecting rod 5 is provided with screw threads and scales on its outer surface. The scales are used to indicate amounts of displacement of the transparent cover plate 3 or angles at which the light blocking walls 2 are deflected. The knob 6 is maintained at a relatively constant position to the plate-shaped substrate 1, for example, by abutting against a stop plate (unshown) on its left side. The knob 6 has a threaded hole for engaging with the screw threads of the connecting rod 5. Initially, the knob 6 is located at a reference position on the connecting rod 5. Then the knob 6 is rotated, and thereby the connecting rod 5 is moved relative to the knob 6, causing the transparent cover plate 3 to move accordingly relative to the plate-shaped substrate 1. Position of the knob 6 on the connecting rod 5 is changed during the movement of the connecting rod 5. Once the knob 6 is moved to a desired scale, the rotation of the knob 6 is stopped, and the adjusting procedure ends. Correspondingly, the transparent cover plate 3 has been moved to a desired position with respect to the plate-shaped substrate 1.

Specifically, the connecting rod 5 moves in a first direction when the knob 6 is rotated for example in a clockwise direction, and the movement of the connecting rod 5 causes the transparent cover plate 3 to move in the first direction, and in turn, the light blocking walls 2 are deflected towards the first direction. Accordingly, the connecting rod 5 moves in a second direction opposite to the first direction when the knob 6 is rotated for example in a counter-clockwise direction, and the movement of the connecting rod 5 causes the transparent cover plate 3 to move in the second direction, and in turn, the light blocking walls 2 are deflected towards the second direction. Once the knob 6 is relatively moved to a desired scale on the connecting rod 5, the rotation of the knob 6 may be stopped.

An anti-peeping device according to the third embodiment of the present invention is shown in FIG. 7.

Instead of the manual adjusting device, an automatic adjusting device may be provided to automatically adjust the unallowed range of viewing angle of the light blocking walls 2. Specifically, as shown in FIG. 7, the automatic adjusting device comprises: a rotational driving device, for example, a motor 7, or specifically a step motor; a leading screw 8 connected to the output of the motor 7; a nut 9 mounted on the leading screw 8 and fastened to the transparent cover plate 3; and a control device 10 electrically or wirelessly connected to the motor 7 for controlling the operation of the motor 7.

The control device 10 may comprise an input interface or an input unit, through which a user may input data, such as direction and angle of the deflection of the light blocking walls 2, into the control device.

In an exemplary embodiment, the input unit comprises a first button and a second button. The first button is used to input a signal for instructing the motor 7 to rotate for example in a clockwise direction, so that the leading screw 8 rotates in the clockwise direction, and the light blocking walls 2 are caused to deflect toward a first direction. The second button is used to input a signal for instructing the motor 7 to rotate for example in a counter-clockwise direction, so that the leading screw 8 rotates in the counter-clockwise direction, and the light blocking walls 2 are caused to deflect toward a second direction opposite to the first direction. Furthermore, the first button and the second button may be configured such that when the first or the second button is continuously pressed down, the control device 10 controls the motor 7 and thus the leading screw to rotate continuously, so that the light blocking walls 2 are continuously deflected toward the first button or the second direction. When the light blocking walls 2 have been deflected to a desired position, the continuous deflection of the light blocking walls 2 can be stopped by releasing the first button or the second button.

In another exemplary embodiment, the input unit comprises a plurality of (for example, two) first buttons and/or a plurality of (for example, two) second buttons. Each of the first buttons or the second buttons corresponds to a predetermined angle at which the light blocking walls 2 are to be deflected. For example, one of the first buttons may be used to deflect the light blocking walls 2 at a first angle (for example 30°) towards the first direction, and another of the first buttons may be used to deflect the light blocking walls 2 at a second angle (for example, 60°) towards the first direction. And/or, one of the second buttons may be used to deflect the light blocking walls 2 at a first angle (for example, 30°) towards the second direction, and another of the first buttons may correspond to deflecting the light blocking walls 2 at a second angle (for example, 60°) towards the second direction. For example, when one of the first buttons is pressed down, the control device 10 sends corresponding instruction to the motor 7 to rotate the leading screw 8 and bring the transparent cover plate 3 to a predetermined position corresponding to the button, such that accurate adjustment of the light blocking walls 2 may be achieved.

An anti-peeping device according to the fourth embodiment of the present invention is shown in FIG. 8. As shown in FIG. 8, the anti-peeping device according to the fourth embodiment comprises a transparent plate-shaped substrate 1, a transparent cover plate 3, and a plurality of light blocking walls 2 deflectably disposed between the plate-shaped substrate 1 and the transparent cover plate 3. The plurality of light blocking walls 2 are disposed to be spaced apart from and in parallel with one another. One end of each light blocking wall 2 is deflectably connected to the plate-shaped substrate 1, while the other end is deflectably connected to the transparent cover plate 3. Therefore, when the transparent cover plate 3 is moved relative to the plate-shaped substrate 1, each light blocking wall 2 is deflected through the movement of the transparent cover plate 3.

The anti-peeping device further comprises: a driving device for driving the transparent cover plate 3 to move; an information acquiring device for acquiring, for example, features of a user's face; and a control device electrically or wirelessly connected to the driving device and the information acquiring device.

In this embodiment of the anti-peeping device, predetermined features of a predetermined user's face are preset. For example, an image of the predetermined user's face is captured by a camera, and the predetermined features are acquired based on the image and are stored in the control device. The information acquiring device is used to acquire features of a current user's face, for example, an image of current user's face, and provide the acquired features to the control device. The control device compares the acquired features with the predetermined features to determine whether or not the current user is the predetermined user. If it is determined that the current user is the predetermined user, an automatic anti-peeping function is activated. After that, the information acquiring device acquires position information of the current user in real time and provides acquired position information to the control device. The control device controls the deflection direction and deflection angle of the light blocking walls 2 based on a relative position relationship between current user and the anti-peeping device, such that an automatic anti-peeping function can be achieved. Furthermore, if the current user moves out of an identifying region of the anti-peeping device, or the current user initiatively ends the automatic anti-peeping function, the automatic anti-peeping process is ended.

Control methods for the above embodiments are further provided.

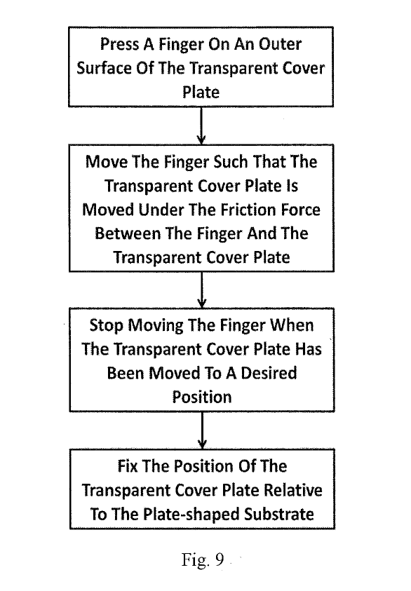

The control method shown in FIG. 9 corresponds to the anti-peeping device according to the first embodiment of the present invention. The control method may comprises steps of pressing a finger on the outer surface of the transparent cover plate 3; moving the finger to move the transparent cover plate 3 through a friction force between the finger and the outer surface of the transparent cover plate 3; stopping moving the finger when the transparent cover plate 3 has been moved to a desired position; and fixing the transparent cover plate 3 through any suitable fixing device.

That is to say, the user may press his/her finger on the outer surface of the transparent cover plate 3 and move the finger, and the transparent cover plate 3 will be moved towards a first direction or a second direction opposite to the first direction through a friction force between the finger and the outer surface of the transparent cover plate 3, such that the light blocking walls of the anti-peeping device are deflected towards the first or the second direction, and thereby the unallowed range of viewing angle can be changed.

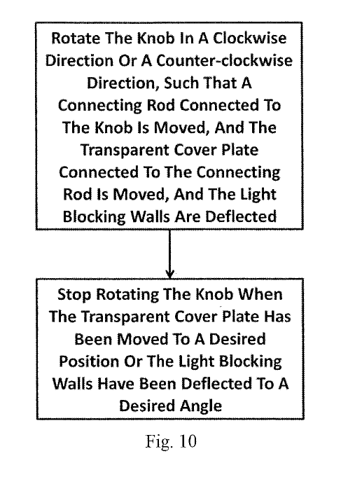

The control method shown in FIG. 10 corresponds to the anti-peeping device according to the second embodiment of the present invention. The control method may comprise steps of:

Step 1: rotating the knob 6, such that the connecting rod 5 is moved relative to the knob 6 in a first direction, causing the transparent cover plate 3 to move accordingly relative to the plate-shaped substrate 1 in the first direction, and the light blocking walls 2 are deflected towards the first direction accordingly; and

Step 2: watching scales on the connecting rod 5 to determine the allowed range of viewing angle of the light blocking walls 2 when the connecting rod 5 is moved, and stopping rotating the knob 6 when the knob 6 has been moved to a desired scale on the connecting rod 5.

Optionally, the method may further comprise steps of:

Step 3: rotating the knob 6 in a reverse direction, such that the connecting rod 5 is moved relative to the knob 6 in a second direction opposite to the first direction, causing the transparent cover plate 3 to move accordingly relative to the plate-shaped substrate 1 in the second direction, and the light blocking walls 2 are deflected towards the second direction accordingly; and

Step 4: watching scales on the connecting rod 5 to determine the allowed range of viewing angle of the light blocking walls 2 when the connecting rod 5 is moved, and stopping rotating the knob 6 when the knob 6 has been moved to a desired scale on the connecting rod 5.

Briefly, a user may rotate the knob 6 so as to move the connecting rob 5 relative to the knob, the movement of the connecting rod 5 causes the transparent cover plate 3 to move, and in turn, the light blocking walls 2 are deflected, such that the unallowed range of viewing angle can be changed.

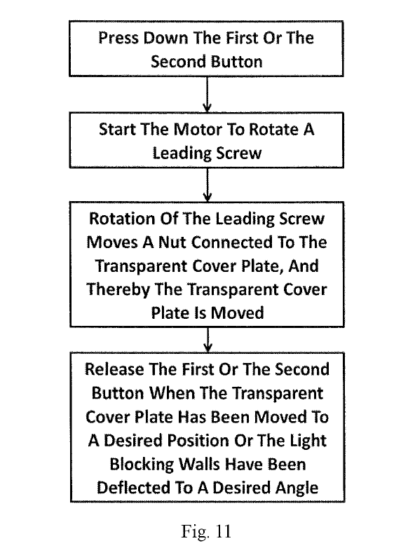

The control method shown in FIG. 11 corresponds to the anti-peeping device according to the third embodiment of the present invention. The control method may comprise steps of:

Step 1: pressing down the first button to input an instruction of deflecting the light blocking walls 2 towards a first direction;

Step 2: receiving and sending the instruction through the controller to the motor 7, so that the motor 7 starts to rotate in one direction;

Step 3: driving the leading screw 8 to rotate through the motor 7, such that the nut 9 is caused to move in the first direction, and in turn the light blocking walls 2 are deflected towards the first direction by the transparent cover plate 3 connected to the nut 9; and

Step 4: stopping driving the leading screw 8 when the light blocking walls 2 have been deflected to a desired deflection angle.

Alternately, the control method may further comprise the following steps:

Step 5: pressing down the second button to input an instruction of deflecting the light blocking walls 2 towards a second direction opposite to the first direction;

Step 6: receiving and sending the instruction through the controller to the motor 7, so that the motor 7 starts to rotate in a reversed direction;

Step 7: driving the leading screw 8 to rotate through the motor 7, such that the nut 9 is caused to move in the second direction, and in turn the light blocking walls 2 are deflected towards the second direction by the transparent cover plate 3 connected to the nut 9; and

Step 8: stopping driving the leading screw 8 when the light blocking walls 2 have been deflected to a desired deflection angle.

Briefly, a user may press down a certain button, instructing the motor 7 to rotate and drive the transparent cover plate 3 to move in a desired direction, thereby the light blocking walls 2 are deflected towards the desired direction by a desired angle, such that the unallowed range of viewing angle can be changed.

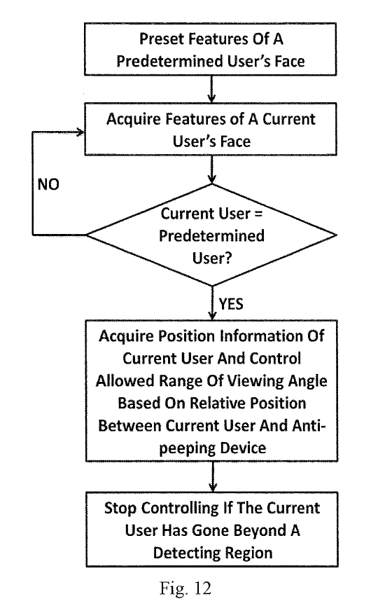

The control method shown in FIG. 12 corresponds to the anti-peeping device according to the fourth embodiment of the present invention. The control method may comprise steps of:

Step 1: presetting predetermined features of a predetermined user's face and storing the predetermined features in the control device;

Step 2: using the information acquiring device to acquire features of a current user's face, and providing the acquired features to the control device;

Step 3: using the control device to compare the acquired features with the predetermined features to determine whether or not the current user is the predetermined user;

Step 4: repeating Step 2 and Step 3 if it is determined that the current user is not the predetermined user, until it is determined that the current user is the predetermined user;

Step 5: using the information acquiring device to acquire position information of the current user in real time and providing acquired position information to the control device, if it is determined that the current user is the predetermined user

Step 6: controlling deflection direction and deflection angle of the light blocking walls based on a relative position relationship between current user and the anti-peeping device.

Briefly, the control method for anti-peeping device according to the fourth embodiment of the invention comprises: presetting predetermined features of a predetermined user's face; acquiring features of a current user's face; comparing the acquired features with the predetermined features to determine whether or not the current user is the predetermined user; repeating the acquiring step and the comparing step if the current user is not the predetermined user; activating an automatic anti-peeping function and acquiring position information of the current user in real time, if the current user is the predetermined user; adjusting or changing deflection direction and deflection angle of the light blocking walls based on a relative position relationship between current user and the anti-peeping device. Optionally, if the current user moves out of an identifying region of the anti-peeping device, or the current user initiatively ends the automatic anti-peeping function, the automatic anti-peeping process ends.

In the above control method, the comparing step may be realized through many different ways. For example, if a predetermined condition is met, the control device determines that the current user is the predetermined user. The predetermined condition may be met when the features of the current user's face totally consist with the predetermined features, or when the features of the current user's face at least 90% consist with the predetermined features. In another example, the features of the current user's face may be processed through an algorithm, and the processed features are compared with the predetermined features.

It is to be noted that specific technical features, structures, and materials throughout the specification can be combined in a suitable way, as long as it does not conflict with basic principles of the present invention.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is,

1. An anti-peeping device, comprising:
a plate-shaped substrate;
a transparent cover plate disposed in parallel with the plate-shaped substrate; and
a plurality of light blocking walls located between the transparent cover plate and the plate-shaped substrate, the plurality of light blocking walls being disposed in parallel with and spaced apart from one another,
wherein a first end of each light blocking wall is deflectably connected to the plate-shaped substrate, and a second end of each light blocking wall opposite to the first end is deflectably connected to the transparent cover plate, such that each light blocking wall is deflected when the transparent cover plate moves relative to the plate-shaped substrate.

2. The anti-peeping device according to claim 1, wherein the light blocking walls are spaced apart with a constant interval.

3. The anti-peeping device according to claim 1, wherein the cross section of each light blocking wall is in shape of a triangle, a trapezoid, or a rectangle.

4. The anti-peeping device according to claim 1, wherein each light blocking wall is a flexible light blocking wall, or each light blocking wall is a rigid light blocking wall deflectably connected to the transparent cover plate and the plate-shaped substrate through flexible connections.

5. The anti-peeping device according to claim 1, wherein regions between adjacent light blocking walls are light transmitting regions, and wherein each light blocking wall comprises a light blocking face that faces its corresponding light transmitting region.

6. The anti-peeping device according to claim 5, wherein the light blocking face is a light reflecting face, and each light blocking wall is made from a light reflecting material, or each light blocking wall comprises a light reflecting outer layer.

7. The anti-peeping device according to claim 5, wherein the light blocking face is a light absorbing face, and each light blocking wall is made from a light absorbing material, or each light blocking wall comprises a light absorbing outer layer.

8. The anti-peeping device according to claim 1, wherein the plate-shaped substrate comprises a transparent substrate or display panel.

9. The anti-peeping device according to claim 1, further comprising two flexible isolators disposed between the plate-shaped substrate and the transparent cover plate,
wherein both of the plate-shaped substrate and the transparent cover plate are in a shape of a rectangle, and the two flexible isolators are disposed at two opposite outer edges of the plate-shaped substrate and in parallel with each of the light blocking walls.

10. The anti-peeping device according to claim 1, further comprising four flexible isolators disposed between the plate-shaped substrate and the transparent cover plate,
wherein both of the plate-shaped substrate and the transparent cover plate are in a shape of a rectangle, and the four flexible isolators are disposed at four outer edges of the plate-shaped substrate and interconnected to form an integral structure.

11. The anti-peeping device according to claim 1, further comprising a fixing device for fixing the transparent cover plate at a desired position relative to the plate-shaped substrate.

12. The anti-peeping device according to claim 11, wherein the fixing device comprises:
a rack connected to one of the plate-shaped substrate and the transparent cover plate; and
a toothed block secured to the other one of the plate-shaped substrate and the transparent cover plate,
wherein the toothed block is configured to engage with the rack at plurality of positions, so as to fix the transparent cover plate at different positions relative to the plate-shaped substrate.

13. The anti-peeping device according to claim 1, further comprising a stop device secured to the plate-shaped substrate for limiting a maximum displacement of the transparent cover plate relative to the plate-shaped substrate.

14. The anti-peeping device according to claim 13, wherein the stop device comprises a stop plate or a stop block.

15. The anti-peeping device according to claim 1, further comprising a manual adjusting device for controlling a relative positional relationship between the transparent cover plate and the plate-shaped substrate, the manual adjusting device comprising:
a connecting rod with one end thereof connected to the transparent cover plate, the connecting rod comprising screw threads on its outer surface; and
a knob having a threaded hole for engaging with the screw threads of the connecting rod,
wherein the knob is threaded onto the connecting rod and is retained at a fixed position relative to the plate-shaped substrate, such that rotation of the knob causes the connecting rod to move and in turn causes the transparent cover plate to move relative to the plate-shaped substrate.

16. The anti-peeping device according to claim 15, wherein the connecting rod further comprises a plurality of scales on its outer surface, and each scale corresponds to an angle at which the light blocking walls are deflected or a displacement of the transparent cover plate relative to the plate-shaped substrate.

17. The anti-peeping device according to claim 1, further comprising an automatic adjusting device for controlling a relative positional relationship between the transparent cover plate and the plate-shaped substrate, the automatic adjusting device comprising:
a leading screw;
a nut threaded onto the leading screw, the nut being securely connected to the transparent cover plate;
a driving device for rotating the leading screw;
an input unit for receiving an instruction from a user; and
a controller configured to control the driving device to rotate the leading screw based on the received instruction.

18. The anti-peeping device according to claim 17, wherein the input unit comprises a first button and a second button, the first button is configured to be pressured down so as to cause the leading screw to rotate in one direction, and the second button configured to be pressured down so as to cause the leading screw to rotate in a reverse direction, and
the first button and the second button are configured such that when the first button or the second button is pressed down, the leading screw continues to rotate until the first button or the second button is released.

19. The anti-peeping device according to claim 17, wherein the input unit comprises a plurality of first buttons and a plurality of second buttons, each first button is configured to be pressed down so as to cause the light blocking walls to respectively deflect to a first predetermined angle towards a first direction, and each second button is configured to be pressed down so as to cause the light blocking walls to respectively deflect to a second predetermined angle towards a second direction opposite to the first direction.

20. The anti-peeping device according to claim 1, further comprising:
a driving device for moving the transparent cover plate or deflecting the light blocking walls;
an information acquiring device for acquiring features of a current user's face; and
a control device,
wherein the control device is configured to receive the acquired features, conduct a comparison between the acquired features and predetermined features of a predetermined user's face stored therein, and control the driving device and the information acquiring device based on a result of the comparison.

21. The anti-peeping device according to claim 20, wherein the control device is further configured to control operations of the driving device based on position information of the current user acquired by the information acquiring device in real time.

22. A control method for the anti-peeping device according to claim 1, the control method comprising steps of:
moving the transparent cover plate;
stopping moving the transparent cover plate when the transparent cover plate has been moved to a desired position; and
fixing the position of the transparent cover plate relative to the plate-shaped substrate.

23. The control method according to claim 22, wherein the step of moving the transparent cover plate comprises:
pressing a finger on an outer surface of the transparent cover plate facing away from the plate-shaped substrate; and
moving the finger such that the transparent cover plate is moved under a friction force between the finger and the transparent cover plate.

24. The control method according to claim 22,
wherein the anti-peeping device further comprising an automatic adjusting device for controlling a relative positional relationship between the transparent cover plate and the plate-shaped substrate, the automatic adjusting device comprising:
a leading screw;
a nut threaded onto the leading screw, the nut being securely connected to the transparent cover plate;
a driving device for rotating the leading screw;
an input unit for receiving an instruction from a user; and
a controller configured to control the driving device to rotate the leading screw based on the received instruction,
and wherein the control method comprises steps of:
rotating the knob to move the connecting rod, such that the transparent cover plate is moved relative to the plate-shaped substrate; and
stopping rotating the knob when the transparent cover plate has been moved to a desired position.

25. The control method according to claim 24,
wherein the connecting rod further comprises a plurality of scales on an outer surface thereof, and each scale corresponds to an angle at which the light blocking walls are deflected or a displacement of the transparent cover plate relative to the plate-shaped substrate, and
wherein the step of rotating the knob comprises: rotating the knob and watching the location of the knob relative to the scales until the knob is located at a desired scale.

26. The control method according to claim 24,
wherein the input unit comprises a first button and a second button, the first button is configured to be pressured down so as to cause the leading screw to rotate in one direction, and the second button configured to be pressured down so as to cause the leading screw to rotate in a reverse direction, and the first button and the second button are configured such that when the first button or the second button is pressed down, the leading screw continues to rotate until the first button or the second button is released, and
wherein the control method comprising steps of:
pressing down the first or the second button such that the leading screw continues to rotate; and
releasing the first or the second button when the transparent cover plate has been moved to a desired position.

27. A control method for the anti-peeping device according to claim 20, the control method comprising steps of:
presetting predetermined features of a predetermined user's face;
acquiring features of a current user's face;
conducting a comparison between the acquired features and the predetermined features to determine whether or not the current user is the predetermined user; and
controlling the driving device and/or the information acquiring device based on a result of the comparison.

28. The control method according to claim 27, wherein the step of controlling the driving device and/or the information acquiring device comprises:
acquiring position information of the current user in real time and controlling the driving device to move the transparent cover plate relative to the plate-shaped substrate, if it is determined that the current user is the predetermined user; and
repeating the step of acquiring features of a current user's face and the step of conducting a comparison between the acquired features and the predetermined features, until it is determined that the current user is the predetermined user.

29. The control method according to claim 27, further comprising terminating the step of controlling the driving device and/or the information acquiring device, if the current user has gone beyond a detecting region.
